(19) United States
(12) Patent Application Publication
(10) Pub. No.: US 2010/0035139 A1
(43) Pub. Date: Feb. 11, 2010

(54) Low thermal spread battery module

(76) Inventors: Debashis Ghosh, Williamsville, NY (US); John R. Hambruch, Burt, NY (US)

Correspondence Address: Delphi Technologies, Inc., M/C 480-410-202, PO BOX 5052, Troy, MI, 48007, US

(21) Appl. No.: 12/221,704

(22) Filed: Aug. 6, 2008

(51) Int. Cl. H01M 10/50

(52) U.S. Cl. 429/120

(57) ABSTRACT

A battery pack assembly including a plurality of cells surrounded by a spacer for creating a radial space between the cell and cylindrical sections defining a casing. At least two of the cylindrical sections are conical or in different radial positions to define differing volumes between the respective two cells. Each of the cylindrical sections may be eccentrically offset from the respective cell to define a greater radial space adjacent the air inlet chamber and a lesser radial space adjacent the respective exit to increase the velocity of the discharging air adjacent the respective exit. Each of the cylindrical sections may have a casing undulating surface extending circumferentially and/or each of the walls of the cells may have a similar cell undulating surface to increase the cooling capacity of the cooling air.

### BACKGROUND OF THE INVENTION

1. Field of the Invention

The present invention relates to a battery pack assembly for providing electrical power.

2. Description of the Prior Art

It is well known to combine a number of battery packs, each including a number of individual cells, for providing electrical power. Heat is generated as electrical current flows into and out of the cells, which heat can have a significant negative impact on the performance and lifetime of the cells and of the battery pack assembly as a whole, if the heat is not effectively managed. Limiting the temperature difference from cell to cell in a battery pack can be important in maximizing the performance and lifetime of the entire battery pack assembly.

To maintain the battery packs and the cells at a desired temperature, a cooling system is often provided within the battery pack assembly. Conventionally, these cooling systems pass air over and around the battery packs and the cells via an inlet manifold and an outlet manifold. In this type of system, the cooling air absorbs heat as it passes over the cells and loses its capacity to absorb heat as it passes over the cells to create temperatures cooler near the inlet manifold than the warmer temperatures near the outlet manifold. As an example, the U.S. Pat. No. 6,569,556 to Zhou et al., discloses a cooling system including an inlet manifold and an outlet manifold that direct an air flow through the cells.

To convey cooling air over the cells, these types of cooling systems define, in each battery pack, an air path from the inlet manifold, over the cells, and to the outlet manifold. Each of the air paths includes an air inlet chamber extending the length of the respective battery pack. Each air path is defined on one side by the cylindrical walls of the cells. Each of the cells has an exposed portion being the portion of the respective cell adjacent and exposed to the air inlet chamber. Each of the battery packs includes a casing having a front and a back for nesting the cells in a stacked configuration. Each of the cells includes a spacer wrapping around the cylindrical wall of the cell for creating a radial space extending radially between the cell and the casing longitudinally adjacent the spacer.

One known type of casing includes a plurality of cylindrical sections each axially aligned along the cell axis of the stack and circling around a semi-cylindrical portion of one of the cells of the stack with each of the cylindrical sections associated with one of the cells for defining and enclosing the radial space around the semi-cylindrical portion of the respective cell. The casing includes a reverse-L-shaped piece spaced from a remainder portion of the stack and further defining the air inlet chamber as the enclosed space around the remainder portion of the stack. The aligned cylindrical sections and the reverse-L-shaped piece combine to completely enclose the stack with the cylindrical sections enclosing the semi-cylindrical portion of the respective cells and the reverse-L-shaped piece enclosing the remainder portion. Each of the cylindrical sections defines an exit axially aligned in the respective cylindrical section of the casing diametrically opposite to the reverse-L-shaped for discharging air away from the respective cell.

Although the prior art discloses systems that cool cells and within a battery pack assembly by passing cooling air through the assembly, significant temperature differences occur from cell to cell due to the non-uniform nature of the cooling air. These temperature differences are detrimental to the performance and lifetime of the battery pack assembly.

### SUMMARY OF THE INVENTION

The invention provides for such a battery pack assembly wherein at least two of the cylindrical sections are in different radial positions relative to the cell axis to define differing volumes in the radial spaces between the respective two cells.

By differing the volume of the spaces around the cells, the volume of cooling air flowing over the cells via the respective radial spaces will also differ. As the volumes of cooling air are different, the capacity of that cooling air to absorb heat and cool the respective cell differs. Accordingly, the volume of the cooling air can be metered from cell to cell to achieve minimal temperature difference from cell to cell.

Also, each cylindrical section around a respective cell can be eccentrically offset from the cell axis to define a greater radial space adjacent the air inlet chamber and a lesser radial space adjacent the respective exit for increasing the velocity of the discharging air adjacent the respective exit.

Such an increase in the velocity of the discharging air adjacent the respective exit increases the heat transfer coefficient of the cooling air adjacent the respective exit, and thus increases its ability to absorb heat and cool more effectively.

Additionally, each cylindrical section around a respective cell may include a casing undulating surface extending circumferentially to define longitudinally extending alternating valleys and peaks with the valleys facing radially outwardly and the peaks facing radially inwardly. Each wall of each cell may include a cell undulating surface extending circumferentially to define longitudinally extending alternating valleys and peaks with the valleys facing radially inwardly and the peaks facing radially outwardly. The inwardly facing valleys of cell undulating surface align radially with the outwardly facing valleys of the casing undulating surface.

This alignment creates unsteady laminar flow of the cooling air thereby increasing the cooling capacity of the cooling air.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a fragmentary perspective view of an embodiment of the invention;

FIG. 2 is a perspective view and in partial cross-section of a pair of battery packs used in the embodiment of FIG. 1;

FIG. 3 is a fragmentary front perspective view with half of the casing removed to show the cells;

FIG. 4 is a schematic view showing the eccentrical offset of the cylindrical sections surrounding the cells;

FIG. 5 is a schematic view illustrating different radial spaces surrounding the cells; and

FIGS. 6-9 are schematic views showing the shields and the undulating surfaces to control flow along the axially aligned and successive cells along each of the stacks as positioned along the axial air flow path from the first cell at the front end of the stack (FIG. 6) to the last cell at the back of the stack (FIG. 9).

### DETAILED DESCRIPTION OF THE EXEMPLARY EMBODIMENT

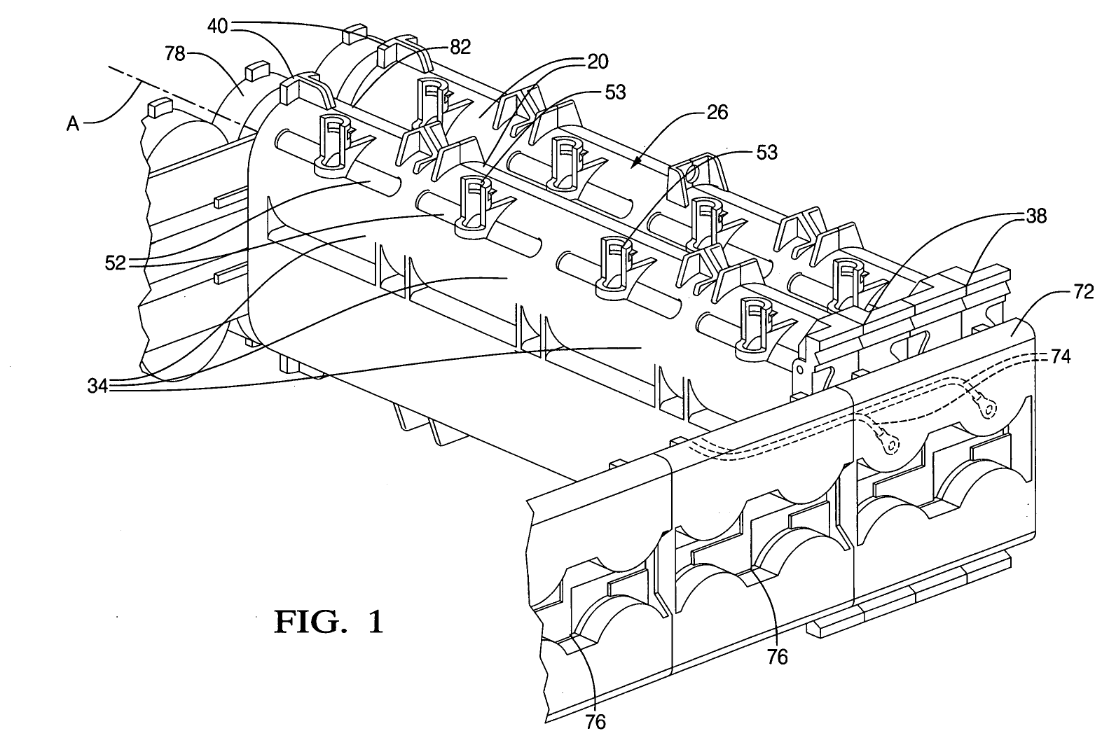

Referring to the Figures, wherein like numerals indicate corresponding parts throughout the several views, a battery pack assembly for providing electrical power is shown, in part, in FIG. 1. The battery pack assembly comprises a plurality of battery packs 20, each generally indicated.

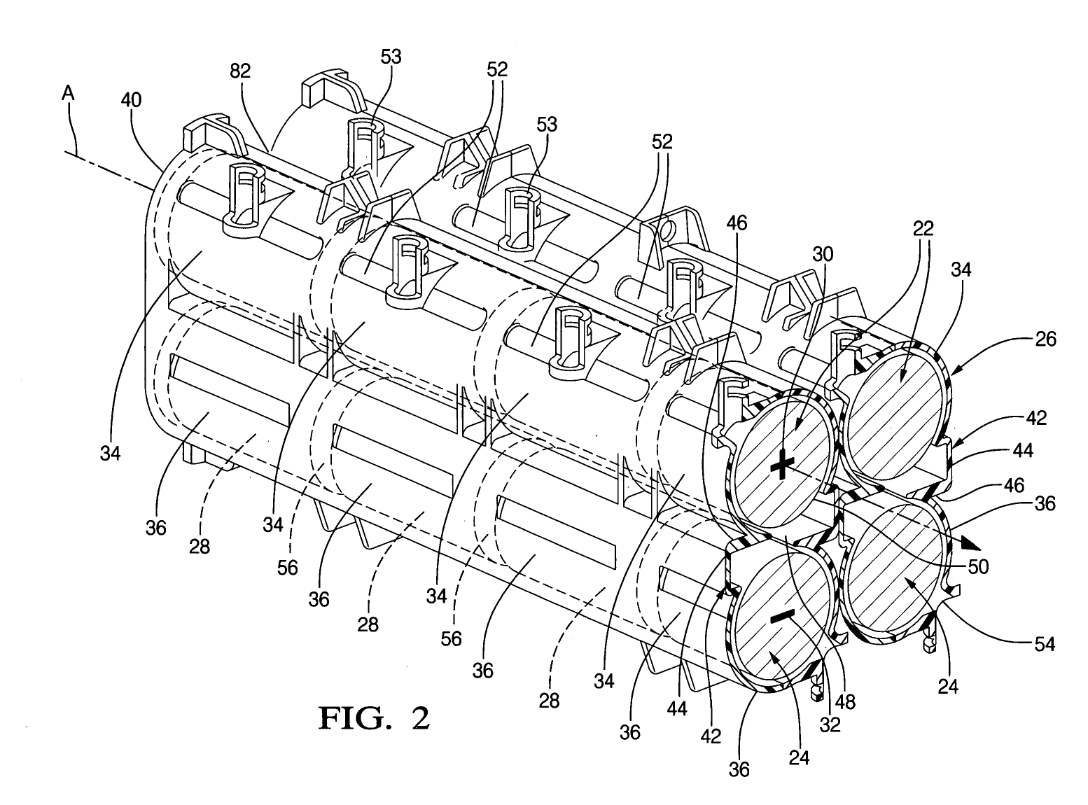

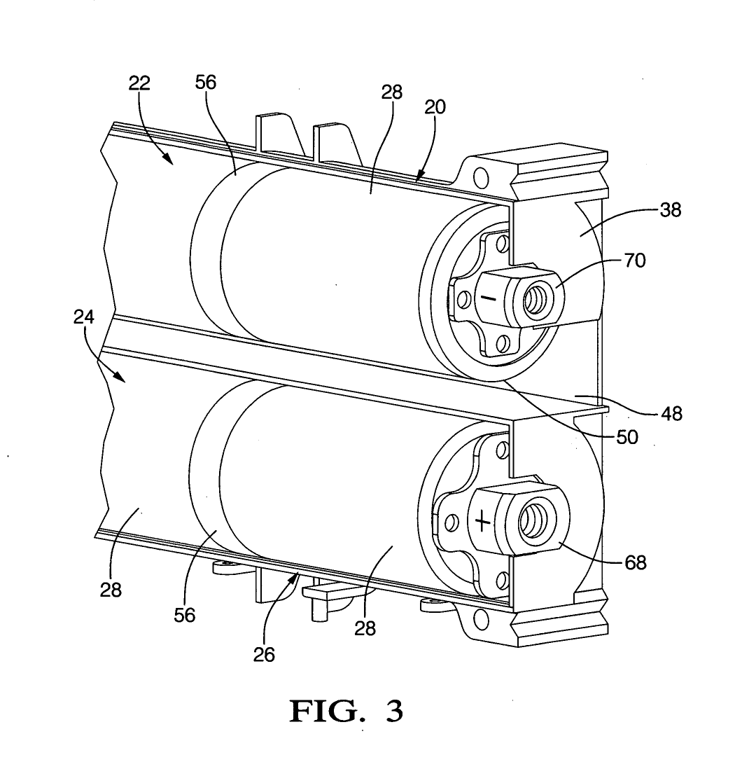

The battery packs 20 are disposed in a side by side relationship, a pair of which are shown in FIG. 2. Each battery pack 20 extends longitudinally and includes an upper stack 22, a lower stack 24, and a casing 26 supporting the stacks 22, 24. All of the stacks 22, 24 are of equal or the same length and extend along parallel and spaced axes A. Although only one axis A is shown for clarity, each stack extends along an axis A. Each stack includes a plurality of cylindrical cells 28 and each cell 28 defines a cylinder and has an anode 30 at one end and a cathode 32 disposed at the opposite end of the cylinder for storing and conducting electrical power. The cells 28 are arranged in cathode-to-anode relationship with one another along the respective axis A, as is well known in the art. The anodes 30 of the cells 28 in the upper stack 22 face in one direction while the anodes 30 of the cells 28 in the lower stack 24 face in the opposite direction, as illustrated in FIG. 3. As such, the cells 28 of each stack are connected to one another in electrical series connection.

The casing 26 includes a plurality of upper cylindrical sections 34, a plurality of lower cylindrical sections 36, a front end cover 38, and a back end cover 40. The front end cover 38 is disposed at the front of the battery pack 20 while the back end cover 40 is disposed at the back of the battery pack 20. The end covers 38, 40 enclose the ends of the casings 26. The casing 26 nests the upper stack 22 above the lower stack 24.

The upper cylindrical sections 34 each axially align with one another along the axis A of the cell 28 of the upper stack 22 and collectively extend along the length of the upper stack 22. Each of the upper cylindrical sections 34 is associated with one of the cells 28 and wraps around a semi-cylindrical portion of the respective cell 28 of the upper stack 22. As illustrated in FIG. 2, the casing 26 also includes a reverse-L-shaped piece 42, generally indicated, to enclose a remainder portion of the upper stack 22. The remainder portion is the portion of the upper stack 22 that is not included in the semi-cylindrical portion. In other words, the remainder portion and the semi-cylindrical portion make up the upper stack 22. The reverse-L-shaped piece 42 includes a long leg 44 that extends vertically and tangentially from the aligned upper cylindrical sections 34 adjacent to the right-hand side of the upper stack 22. The reverse-L-shaped piece 42 also includes a short leg 46 that extends transversely to the long leg 44 and connects with the respective upper cylindrical section 34 adjacent to the bottom side of the upper stack 22. The upper cylindrical sections 34 and the reverse-L-shaped piece 42 combine to completely enclose the upper stack 22. More specifically, the upper cylindrical sections 34 enclose the respective semi-cylindrical portions of the respective cells 28 and the reverse-L-shaped piece 42 encloses the remainder portion. The long leg 44 and the short leg 46 define two sides of a reverse-L-shaped air inlet chamber 48. The remaining side of the air inlet chamber 48 is defined by the cylindrical walls of the remainder portion of the upper stack 22. The air inlet chamber 48 supplies air to the cells 28.

The air inlet chamber 48 is generally right-triangular in cross section. The right-triangular cross section has two legs 44, 46 and a hypotenuse. The long leg 44 and the short leg 46 define the legs 44, 46 of the right-triangular cross section and the cylindrical wall of the remainder portion of the upper stack 22 define the hypotenuse of the right-triangular cross section. The hypotenuse has a slight curvature due to the cylindrical shape of the walls of the cells 28. The air inlet chamber 48 extends along the length of the upper stack 22.

The remainder portion of the upper stack 22 creates an exposed portion 50 on each of the cells 28 that comprise the upper stack 22. The exposed portion 50 is the portion of each cell 28 that is adjacent and directly exposed to the air inlet chamber 48. Further, the exposed portion 50 of each cell 28 is enclosed by and spaced from the reverse-L-shaped piece 42. The semi-cylindrical portion of the upper stack 22 creates a portion on each of the cells 28 of the upper stack 22 that is not directly exposed to the air inlet chamber 48.

Each of the upper cylindrical sections 34 of the casing 26 also defines an upper exit 52 that is axially aligned in the respective upper cylindrical section 34 diametrically opposite the reverse-L-shaped piece 42. The upper exit 52 discharges cooling air flowing from the air inlet chamber 48 and over the respective cell 28 of the upper stack 22. Each upper exit 52 includes a thermistor well 53 extending upwardly from and being in communication with the respective upper exit 52 for measuring the temperature of the cooling air exiting the upper exit 52.

The lower cylindrical sections 36 of the casing 26 have a configuration identical to that of the upper cylindrical sections 34. Each of the lower cylindrical sections 36 is disposed directly below the respective upper cylindrical section 34 and is rotated one hundred eighty degrees (180°) with respect to the upper cylindrical section 34. In this arrangement, the short leg 46 of the upper reverse-L-shaped piece 42 is tangent to the lower cylindrical sections 36 and the short leg 46 of the lower reverse-L-shaped piece 42 is tangent to the upper cylindrical sections 34. As such, the reverse-L-shaped air inlet chambers 48 are open to one another and in fluid communication.

The remainder portion of the lower stack 24 creates an exposed portion 50 on each of the cells 28 that comprise the lower stack 24. The semi-cylindrical portion of the lower stack 24 creates a portion on each of the cells 28 of the lower stack 24 that is not directly exposed to the air inlet chamber 48.

Similar to the upper cylindrical sections 34, each of the lower cylindrical sections 36 defines a lower exit 54 that is axially aligned in the respective lower cylindrical section 36 diametrically opposite the reverse-L-shaped piece 42 and diametrically opposite the upper exit 52 of the respective upper cylindrical section 34. The lower exit 54 discharges cooling air flowing from the air inlet chamber 48 and over the respective cell 28 of the lower stack 24.

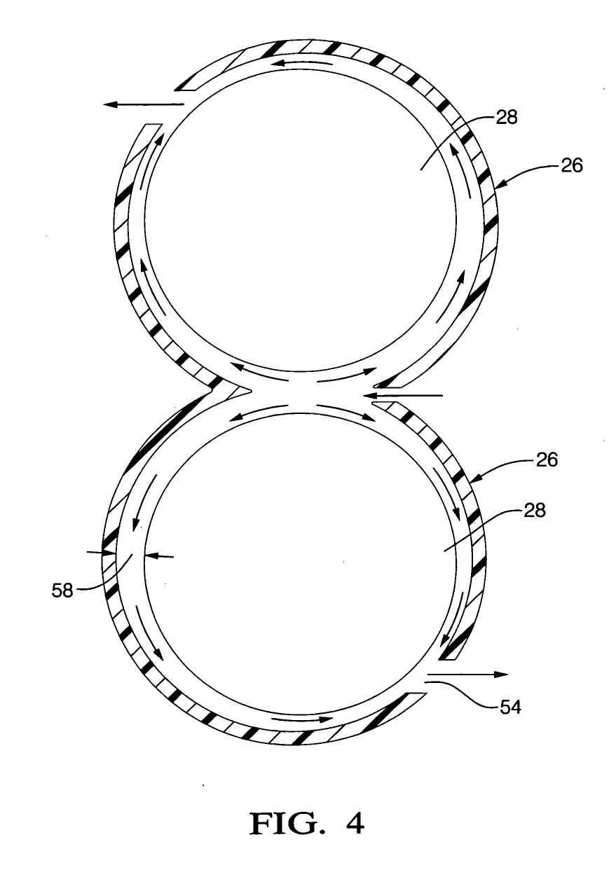

Additionally, each cell 28 includes a spacer 56 which is cylindrical in shape and wraps around the cell 28 to create a radial space 58, shown in FIG. 4, which radial space 58 extends radially between the cell 28 and the casing 26. The radial spaces 58 allow air flow between the cells 28 and the respective cylindrical section of the casing 26. Each of the spacers 56 creates the respective radial space 58 by preventing the respective cylindrical section of the casing 26 from contacting the cells 28. The spacer 56 is made out of an insulating material such as rubber or plastic.

Each of the upper cylindrical sections 34 wraps around the semi-cylindrical portion of one of the cells 28 of the upper stack 22 to define and enclose an upper portion of the radial space 58 around the semi-cylindrical portion of the respective cell 28 of the upper stack 22. Similarly, each of the lower cylindrical sections 36 wraps around the semi-cylindrical portion of one of the cells 28 of the lower stack 24 to define and enclose a lower portion of the radial space 58 around the semi-cylindrical portion of the respective cell 28 of the lower stack 24. The air path created by the cylindrical sections 34, 36 and the spacers 56 flows from the two reverse-L-shaped air inlet chambers 48, along the length of the stacks 22, 24, around the cells 28 via the space created by the spacers 56, and out the exits 52, 54.

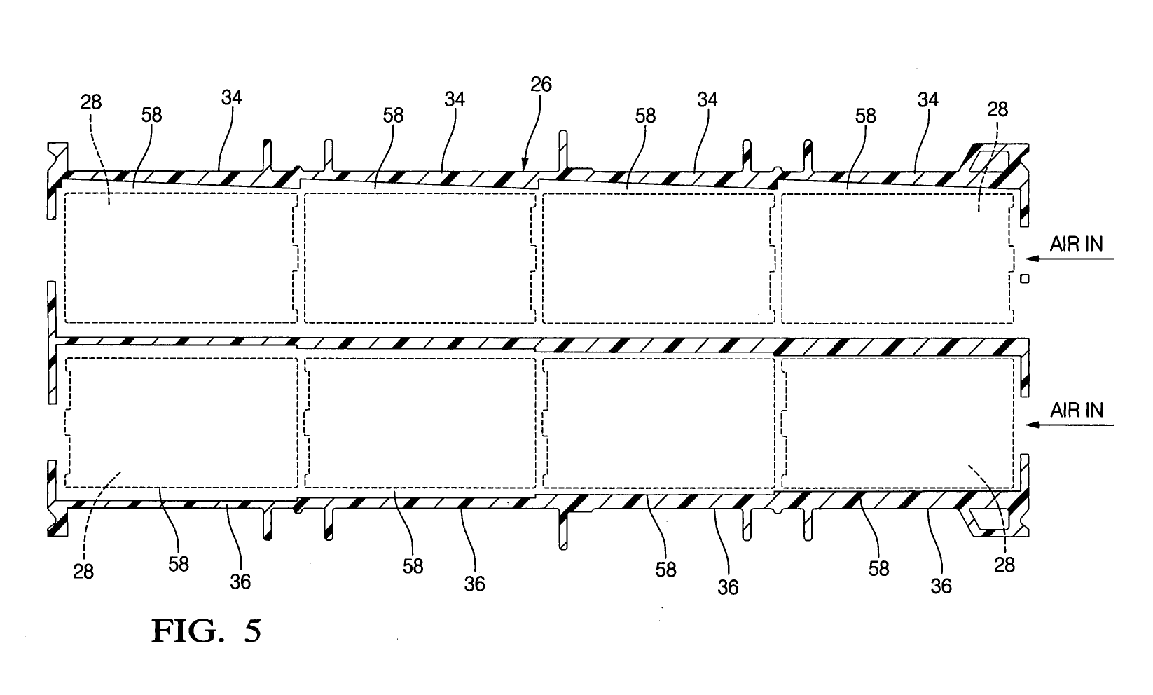

As shown in FIG. 5, at least two of the upper cylindrical sections 34 are in different radial positions relative to the axis A of the cell 28 so as to define differing volumes in the radial spaces 58 between the respective two cells 28. Similarly, at least two of the lower cylindrical sections 36 are in different radial positions so as to define differing volumes in the radial spaces 58 between the respective two cells 28. In one, embodiment, all of the cylindrical sections 34, 36 can differ from one another thereby creating radial spaces 58 of differing volumes around each of the cells 28. By varying the volume of the spaces around the cells 28, the volume of cooling air flowing over the cells 28 via the respective radial spaces 58 will also vary accordingly. As the volume of cooling air changes, the ability of that cooling air to cool the respective cell 28 changes as well. As an example, a particularly hot cell 28 can have a larger radial space 58. As such, more air will flow over the hot cell 28 and the hot cell 28 will be cooled more than another cool cell 28, which would have a smaller radial space 58. By metering the airflow around each of the cells 28 in this manner, the warmer cells 28 at the back of the battery pack 20 are cooled more; and the cooler cells 28 at the front of the battery pack 20 are cooled less, hence, the overall temperature difference from cell 28 to cell 28 is minimized.

In one embodiment, the cylindrical sections 34, 36 can create radial spaces 58 that are generally cylindrical in shape and constant longitudinally along the respective cell 28, albeit, the radial spaces 58 may differ from cell 28 to cell 28. In other words, the radial space 58 (from the wall of the cell 28 to the casing 26) around each cell 28 is the same thickness along the length of each respective cell 28. Alternatively, the cylindrical sections 34, 36 can create radial spaces 58 that are generally conical in shape whereby the radial spaces 58 taper longitudinally along the respective cell 28. In this case, the thickness of the radial space 58 adjacent the front of a particular cell 28 would be less than the thickness of the radial space 58 adjacent the rear of the particular cell 28, i.e., the space will be generally triangular in cross section when viewed from the side of the battery pack 20, as shown in FIG. 5. In one embodiment, the space can taper from 0.8 mm to 1.2 mm from front to back.

As shown in FIG. 4, each of the upper cylindrical sections 34 around the respective cell 28 of the upper stack 22 can be eccentrically offset from the upper stack 22 to define a greater radial space 58 adjacent the air inlet chamber 48 and a lesser radial space 58 adjacent the respective upper exit 52. The lower cylindrical sections 36 can have the same configuration and are rotated one hundred eighty degrees (180°). Such an offset disposition increases the velocity of the discharging air adjacent the respective exit. This increase in velocity increases the heat transfer coefficient of the cooling air adjacent the respective exit.

As the cooling air flows around the respective cell 28, two streams are formed. These two streams are mirror images of one another. The two streams start at the air inlet chamber 48 and meet at the respective exit. As the streams meet, the two streams collide thereby creating an impingement cooling regime. Impingement cooling yields a very high heat transfer coefficient and, as such, cools quite efficiently. The combination of the increase of velocity of the cooling air and the impingement cooling (both adjacent the respective exit) results in extremely efficient cooling. In this case, the respective exits 52, 54 can be wider, thus reducing the pressure drop across the battery pack.

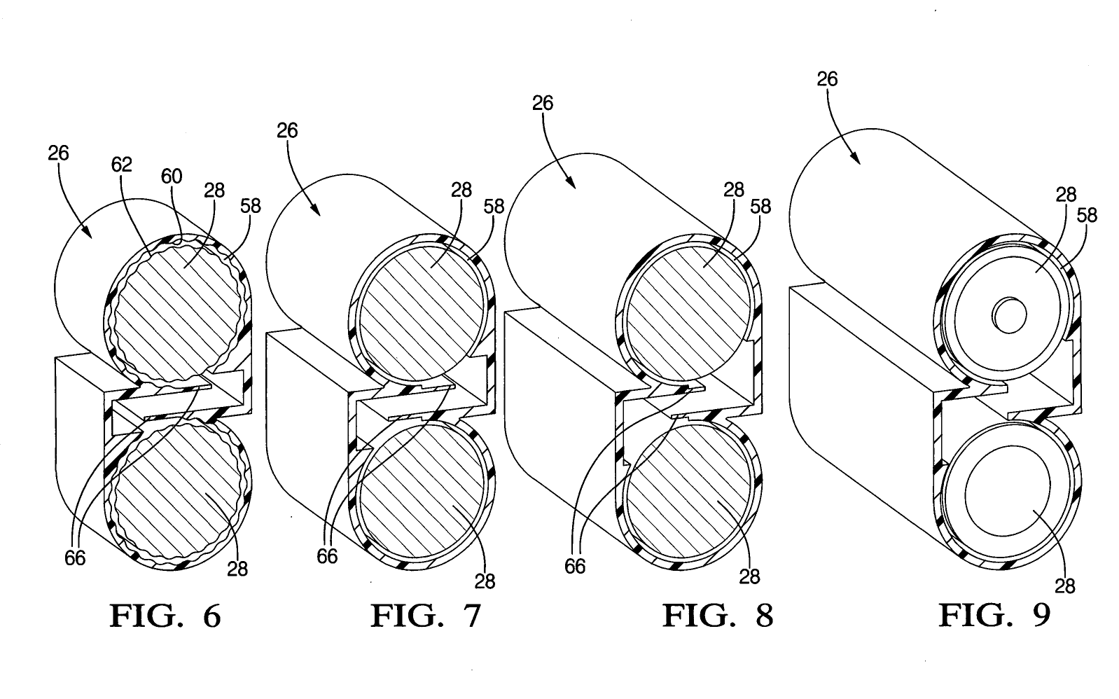

As shown in FIG. 6, each of the upper cylindrical sections 34 of the casing 26 around the respective cells 28 of the upper stack 22 can have a casing undulating surface 60 that extends circumferentially to define longitudinally extending alternating valleys and peaks. The valleys face radially outwardly and the peaks face radially inwardly. Each of the lower cylindrical sections 36 of the casing 26 around the respective cells 28 of the lower stack 24 have an identical casing undulating surface 60.

Each of the walls of the cells 28 can have a cell undulating surface 62 that extends circumferentially to define longitudinally extending alternating valleys and peaks. The valleys face radially inwardly and the peaks face radially outwardly. The inwardly facing valleys of the cell undulating surface 62 of the cells 28 align radially with the outwardly facing valleys of the casing undulating surface 60 of the respective cylindrical section of the casing 26. This alignment of the undulating surfaces 60, 62 creates an unsteady laminar flow of the cooling air which increases the cooling capacity of the cooling air with a minimal increase in pressure drop. Alternatively, the inwardly facing valleys of the cell undulating surface 62 of the cells 28 can align radially with the outwardly facing peaks of the casing undulating surface 60 of the respective cylindrical section of the casing 26. This alignment of the undulating surfaces 60, 62 creates an alternative form of unsteady laminar flow of the cooling air that is different from the alignment discussed above. Additionally, the undulating surfaces 60, 62 can align in a manner such that they are circumferentially staggered from one another.

In one embodiment, the pattern of valleys and peaks can alternate from cell 28 to cell 28, i.e., the number of valleys and peaks can vary from cell 28 to cell 28. An increase in the number of valleys and peaks will result in a higher heat transfer coefficient around the respective cell 28. This allows the cells 28 to be further metered. Hotter cells 28 will have more valleys and peaks than cooler cells 28, hence, the overall temperature drop across the battery pack 20 can be minimized.

In the alternative, the battery pack 20 can utilize cells 28 that have a rectangular cross section. In this case, the walls of the cells 28 can still have a surface that undulates. The cells 28 can be disposed in the respective cylindrical section 34, 36. The corners of the cells 28 will, in this case, contact the respective cylindrical section 34, 36, thus eliminating the need for a spacer 56.

As shown in FIGS. 6, 7, and 8, plurality of shields 66 can be disposed in the air inlet chamber 48. Each shield 66 of the plurality is associated with one of the cells 28 of the particular battery pack 20. Each of the shields 66 blocks a portion of the cooling air from the exposed portion 50 of the respective cell 28. In doing so, each of the shields 66 limits the amount of cooling air conveyed to the radial space 58 around the respective cell 28. Collectively, the shields 66 work to divide and distribute portions of the cooling air to the respective cells 28. As a result, more of the cooling air becomes available to the more rearward cells 28 because the cooling air is not all utilized by the more forward cells 28, hence the flow of air over the cells 28 is effectively metered by the shields 66.

By utilizing the shields 66 to reduce the size of the exposed portion 50 of the respective cell 28, less cooling air is exposed to the respective cells 28 at the front of the battery pack 20. As such, the air that is not exposed remains cool, i.e., the unexposed air is not heated up by the cells 28 at the front of the battery pack 20. The air that reaches the back of the battery pack 20, is cooler in temperature and can better cool the cells 28 at the back of the battery pack 20. As a result, the warmer cells 28 at the back of the battery pack 20 are cooled more; and the cooler cells 28 at the front of the battery pack 20 are cooled less, hence, the overall temperature difference from cell 28 to cell 28 is minimized.

Each of the shields 66 extends longitudinally along the length of one of the cells 28. Each of the shields 66 can additionally extend longitudinally from one spacer 56 to the next successive spacer 56. Each of the shields 66 is generally rectangular in shape and has an area and extends longitudinally along the length of one of the cells 28. The shields 66 can be molded or formed into the casing 26 and, as such, would be integral to the casing 26. Alternatively, the shields 66 can be separate from the casing 26 and can be attached in place as necessary. Each of the shields 66 is tangential to the cylindrical walls of the exposed portion 50 of the respective cell 28. Each of the shields 66 can differ in area from shield 66 to shield 66 so as to differ the exposed portion 50 of the respective cell 28 from cell 28 to cell 28.

As an example, FIG. 6 illustrates the front cells 28 of each of the stacks 22, 24 and the respective shields 66, which shields 66 are larger to block a larger portion of the incoming cooling air. FIG. 7 illustrates the cells 28 that are axially aligned with and in front-to-back succession with the cells 28 of FIG. 6. Here, the shields 66 are slightly smaller in area and block a slightly smaller portion of cooling air. FIG. 8 illustrates the cells 28 that are axially aligned with and in front-to-back succession with the cells 28 of FIG. 7. Here, the shields 66 are significantly smaller than those previous. As a result, significantly less cooling air will be blocked, i.e., more cooling air will reach the respective cells 28. Finally, FIG. 9 illustrates the cells 28 that are axially aligned with and in front-to-back succession with the cells 28 of FIG. 8. Here, no shields 66 are utilized and no cooling air is blocked, i.e., the respective cells 28 receive a full stream of cooling air. In doing this, the exposed portions 50 of the respective cells 28 increase from front to back. The hotter cells 28 at the back of each battery pack 20 receive more cooling air than the cooler cells 28 at the front of the battery pack 20. Also, the air received by the hotter cells 28 at the back of each battery pack 20 is cooler in temperature than it would be without the blocking pieces. As a result, the temperature difference from cell 28 to cell 28 and from front to back is minimized.

Alternatively, the shape of the shields 66 can taper from front to back of the respective cell 28. Also, the shape of the shields 66 can vary to adapt to any other particular configuration of cells 28. Also, each of the shields 66 can extend partially along the length of the respective cell 28, i.e. each shield 66 does not have to extend the entire length of the respective cell 28.

The end covers 38, 40 are generally rectangular in shape. Each of the front end covers 38 defines an entry that aligns with the air inlet chambers 48 for conveying the cooling air through the end cover and into the air inlet chambers 48. The back end covers 40 are solid and prevent cooling air from exiting therethrough. As such, the cooling air is forced over the cells 28 and out the upper and lower exits 52, 54.

As shown in FIG. 3, each of the end covers 38, 40 also includes a positive terminal 68 that aligns with the anode 30 of the outermost the cell 28 of one stack and a negative terminal 70 that aligns with the cathode 32 of the outermost the cell 28 of the other stack. These terminals 68, 70 protrude through their respective end cover and contact the anode 30 or cathode 32 of the respective cell 28 to transmit the electrical power generated by the cells 28 in the stacks 22, 24. To facilitate the loading of the cells 28 into the casings 26, each casing 26 is split longitudinally into two pieces that snap together.

An inlet bus bar 72 is disposed along the front end covers 38 of the battery packs 20 for interconnecting the battery packs 20. The arrangement of the battery packs 20 is such that alternate battery packs 20 having the positive terminal 68 extending from the upper stack 22 are interleaved with battery packs 20 having the positive terminal 68 extending from the lower stack 24. In other words, adjacent battery packs 20 have the reverse terminal configuration. If one battery pack 20 has the positive terminal 68 on the top, the next adjacent battery pack 20 has the positive terminal 68 on the bottom. The inlet bus bar 72 includes a plurality of connection wires 74 for electrically connecting the stacks 22, 24 of one battery pack 20 to one another and the battery packs 20 to one another in series connection. The connection wires 74 of the inlet bus bar 72 connect the positive terminal 68 of one battery pack 20 to the negative terminal 70 of the next adjacent battery pack 20.

The inlet bus bar 72 defines a plurality of openings 76, which openings 76 align with the air inlet chambers 48 for conveying the cooling air through the inlet bus bar 72 and into the air inlet chambers 48. The shape of these openings 76 and the subsequent alignment with the air inlet chambers 48 can vary depending upon the configuration of the battery pack 20 assembly.

Referring generally to all embodiments, an outlet bus bar 78 is disposed along the back end covers 40 of the battery packs 20 for interconnecting the stacks 22, 24 of each battery pack 20. The outlet bus bar 78 also includes a plurality of connection wires 74. The connection wires 74 of the outlet bus bar 78 connect the positive terminal 68 of one battery pack 20 to the negative terminal 70 of the same battery pack 20. The connections of the inlet bus bar 72 and outlet bus bar 78 combine to connect the all the cells 28 of all the battery packs 20 in series.

The outlet bus bar 78 is solid and prevents air from exiting therethrough. As such, the cooling air is forced over the cells 28 and out the upper and lower exits 52, 54.

A housing (not shown) encloses the battery packs 20. The side by side relationship of the casings 26 of the battery packs 20 creates V-shaped channels 82 between adjacent upper cylindrical sections 34 and between adjacent lower cylindrical sections 36. The upper or lower cylindrical sections 34, 36 define the walls of the respective channels 82 while the housing defines top or bottom of the channels 82. Each channel 82 extends the length of the battery pack 20. The upper and lower exits 52, 54 defined by the casing 26 discharge cooling air away from the cells 28 and into the channels 82, which convey the air away from the assembly.

An inlet manifold (not shown) and an outlet manifold (not shown) are disposed at the front and back ends of the battery packs 20, respectively, to establish a flow of cooling air through the assembly. The housing defines a hole through which the inlet manifold supplies cooling air to the system. The housing also defines a hole through which cooling air is conveyed to the outlet manifold, which discharges the cooling air from the assembly.

The inlet manifold extends parallel to the inlet bus bar 72 and is spaced from the front end covers 38 of the casing 26. The inlet bus bar 72 is disposed between the inlet manifold and the front end covers 38. The outlet manifold extends parallel to the inlet manifold and along the back end covers 40 of the casing 26. The outlet bus bar 78 is disposed between the outlet manifold and the backs of the battery packs 20.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A battery pack assembly for providing electrical power comprising:
a plurality of battery packs each including an upper stack and a lower stack extending parallel to one another and disposed in a side by side relationship and defining an air path therethrough for cooling;
each of said stacks extending along a cell axis and including a plurality of cells each having a wall and defining a cylinder for storing and transmitting electrical power;
each of said air paths including an air inlet chamber extending the length of said respective battery pack and being defined on one side by said cylindrical walls of said cells for supplying air to said cells;
each of said battery packs including a casing having a front and a back for nesting said stacks one above the other and for enclosing said stacks;
each of said cells including a spacer being made of an insulating material and wrapping around said cylindrical wall of said cell for creating a radial space extending radially between said cell and said casing longitudinally adjacent said spacer;
said casing including a plurality of cylindrical sections each axially aligned along said cell axis of said stack and circling around a semi-cylindrical portion of one of said cells of one of said stacks with each of said cylindrical sections associated with one of said cells for defining and enclosing said radial space around said semi-cylindrical portion of said respective cell; and
at least two of said cylindrical sections being in different radial positions relative to said cell axis to define differing volumes in said radial spaces between said respective two cells.

2. An assembly as set forth in claim 1 wherein said cylindrical sections are cylindrical for maintaining each of said radial spaces constant longitudinally along each of said respective cells.

3. An assembly as set forth in claim 1 wherein each of said cylindrical sections are conical for increasing said radial spaces longitudinally along each of said cells.

4. An assembly as set forth in claim 1 wherein said casing includes a reverse-L-shaped piece having a long leg extending tangentially from said aligned cylindrical sections to a short leg extending transversely and spaced from a remainder portion of said stack for creating an enclosed space around said remainder portion of said stack to define said air inlet chamber.

5. An assembly as set forth in claim 4 wherein said cylindrical sections and said reverse-L-shaped piece combine to completely enclose said cells of said stack with said cylindrical sections enclosing said semi-cylindrical portions of said respective cells and said reverse-L-shaped piece enclosing said remainder portions.

6. An assembly as set forth in claim 5 wherein said air inlet chamber is defined by said long leg and said short leg and said cylindrical walls of said remainder portion of said stack.

7. An assembly as set forth in claim 6 wherein each of said cylindrical sections defines an exit axially aligned in said respective cylindrical section of said casing diametrically opposite to said reverse-L-shaped piece for discharging air away from said respective cell.

8. An assembly as set forth in claim 1 wherein each of said cylindrical sections around said respective cell of said stack is eccentrically offset from said respective cell to define a greater radial space adjacent said air inlet chamber and a lesser radial space adjacent said respective exit for increasing the velocity of the discharging air adjacent said respective exit.

9. An assembly as set forth in claim 1 wherein each of said cylindrical sections around said respective cell of said stack has an undulating surface extending circumferentially to define longitudinally extending alternating valleys and peaks with said valleys facing radially outwardly and said peaks facing radially inwardly for creating unsteady laminar flow of the cooling air to increase the cooling capacity of the cooling air.

10. An assembly as set forth in claim 9 wherein each of said walls of said cells has an undulating surface extending circumferentially to define longitudinally extending alternating valleys and peaks with said valleys facing radially inwardly and said peaks facing radially outwardly with said inwardly facing valleys of said undulating surface of said cells aligning radially with said outwardly facing valleys of said undulating surface of said respective cylindrical section for creating unsteady laminar flow of the cooling air to increase the cooling capacity of the cooling air.

11. An assembly as set forth in claim 6 wherein said remainder portion of said stack creates an exposed portion on each of said cells of said stack with said exposed portion of each of said cells being the portion of each cell adjacent and directly exposed to said air inlet chamber and enclosed by and spaced from said reverse-L-shaped piece.

12. An assembly as set forth in claim 11 including a plurality of shields disposed in said air inlet chamber with each of said shields associated with one of said cells for shielding a portion of the cooling air from said exposed portion of said respective cell to reduce the flow of cold air over said cells.

13. An assembly as set forth in claim 12 wherein each of said shields is generally rectangular in shape and extends longitudinally along the length of one of said cells.

14. An assembly as set forth in claim 13 wherein each of said shields is tangential to said cylindrical walls of said exposed portion of said respective cell.

15. An assembly as set forth in claim 14 wherein each of said shields varies in area from shield to shield for varying the flow rate of cooling air from cell to cell.

16. An assembly as set forth in claim 1 including plurality of upper cylindrical sections each axially aligning along said cell axis of said upper stack and circling around a semi-cylindrical portion of one of said cells of said upper stack with each of said upper cylindrical sections associated with one of said cells for defining and enclosing said radial space around said semi-cylindrical portion of said respective cell and a plurality of lower cylindrical sections each axially aligning along said cell axis of said lower stack and circling around a semi-cylindrical portion of one of said cells of said lower stack with each of said lower cylindrical sections associated with one of said cells for defining and enclosing said radial space around said semi-cylindrical portion of said respective cell.

17. An assembly as set forth in claim 16 wherein at least two of said upper cylindrical sections being in different radial positions to define differing volumes in said radial spaces between said respective two cells and at least two of said lower cylindrical sections being in different radial positions to define differing volumes in said radial spaces between said respective two cells.

18. A battery pack assembly for providing electrical power comprising:
a plurality of battery packs each including an upper stack and a lower stack extending parallel to one another and disposed in a side by side relationship and defining an air path therethrough for cooling;
each of said stacks extending along a cell axis and including a plurality of cells each having a wall and defining a cylinder for storing and transmitting electrical power;
each of said air paths including an air inlet chamber extending the length of said respective battery pack and being defined on one side by said cylindrical walls of said cells for supplying air to said cells;
each of said battery packs including a casing having a front and a back for nesting said stacks one above the other and for enclosing said stacks;
each of said cells including a spacer being made of an insulating material and wrapping around said cylindrical wall of said cell for creating a radial space extending radially between said cell and said casing longitudinally adjacent said spacer;
said casing including a plurality of cylindrical sections each axially aligned along said cell axis of said stack and circling around a semi-cylindrical portion of one of said cells of one of said stacks with each of said cylindrical sections associated with one of said cells for defining and enclosing said radial space around said semi-cylindrical portion of said respective cell;
said casing including a reverse-L-shaped piece having a long leg extending tangentially from said cylindrical sections to a short leg extending transversely and spaced from a remainder portion of said stack for creating an enclosed space around said remainder portion of said stack to define said air inlet chamber;
said cylindrical sections and said reverse-L-shaped piece combining to completely enclose said cells of said stack with said cylindrical sections enclosing said semi-cylindrical portions of said respective cells and said reverse-L-shaped piece enclosing said remainder portion of said cells;
said air inlet chamber being defined by said long leg and said short leg and said cylindrical walls of said remainder portion of said stack;
each of said cylindrical sections defining an exit axially aligned in said respective cylindrical section of said casing diametrically opposite to said reverse-L-shaped piece for discharging air away from said respective cell; and
each of said cylindrical sections around said respective cell of said stack being eccentrically offset from said respective cell of said stack to define a greater radial space adjacent said air inlet chamber and a lesser radial space adjacent said respective exit for increasing the velocity of the discharging air adjacent said respective exit.

19. A battery pack assembly for providing electrical power comprising:
a plurality of battery packs each including an upper stack and a lower stack extending parallel to one another and disposed in a side by side relationship and defining an air path therethrough for cooling;
each of said stacks extending along a cell axis and including a plurality of cells each having a wall and defining a cylinder for storing and transmitting electrical power;
each of said air paths including an air inlet chamber extending the length of said respective battery pack and being defined on one side by said cylindrical walls of said cells for supplying air to said cells;
each of said battery packs including a casing having a front and a back for nesting said stacks one above the other and for enclosing said stacks;
each of said cells including a spacer being made of an insulating material and wrapping around said cylindrical wall of said cell for creating a radial space extending radially between said cell and said casing longitudinally adjacent said spacer;
said casing including a plurality of cylindrical sections each axially aligned along said cell axis of said stack and circling around a semi-cylindrical portion of one of said cells of one of said stacks with each of said cylindrical sections associated with one of said cells for defining and enclosing said radial space around said semi-cylindrical portion of said respective cell;
each of said cylindrical sections of said casing around said respective cell of said stack having a casing undulating surface extending circumferentially to define longitudinally extending alternating valleys and peaks with said valleys facing radially outwardly and said peaks facing radially inwardly for creating unsteady laminar flow of the cooling air to increase the cooling capacity of the cooling air; and
each of said walls of said cells having a cell undulating surface extending circumferentially to define longitudinally extending alternating valleys and peaks with said valleys facing radially inwardly and said peaks facing radially outwardly with said inwardly facing valleys of said cell undulating surface of said cells aligning radially with said outwardly facing valleys of said casing undulating surface of said respective cylindrical section of said casing for creating unsteady laminar flow of the cooling air to increase the cooling capacity of the cooling air.
